(19) United States
(12) Patent Application Publication
(10) Pub. No.: US 2011/0270972 A1
(43) Pub. Date: Nov. 3, 2011

(54) VIRTUAL TOPOLOGY ADAPTATION FOR RESOURCE OPTIMIZATION IN TELECOMMUNICATION NETWORKS

(75) Inventors: Biswanath Mukherjee, Davis, CA (US); Pulak Kumar Chowdhury, Davis, CA (US)

(73) Assignee: THE REGENTS OF THE UNIVERSITY OF CALIFORNIA, Oakland, CA (US)

(21) Appl. No.: 13/091,906

(22) Filed: Apr. 21, 2011

Related U.S. Application Data
(60) Provisional application No. 61/330,126, filed on Apr. 30, 2010.

(51) Int. Cl. G06F 15/173

(52) U.S. Cl. 709/224

(57) ABSTRACT

Some embodiments described in this disclosure provide methods and apparatuses for managing a network, e.g., by performing virtual topology adaptation for resource optimization. In some embodiments, a system can monitor traffic on the network to identify heavily loaded and/or lightly loaded links in the network. In response to identifying a lightly loaded link, the system can shift traffic from the lightly loaded link to one or more other links in the network. After the traffic has been shifted, the system can move circuitry associated with the lightly loaded link into a low-power state. In response to identifying a heavily loaded link, the system can activate a new link in the network by moving circuitry associated with the new link from a low-power state into a high-power state. After the new link has been activated, the system can shift traffic from the heavily loaded link to the new link.

### RELATED APPLICATION

This application claims priority to U.S. Provisional Application No. 61/330,126, Attorney Docket Number UC 10-026-1PSP, entitled “Virtual Topology Adaptation for Resource Optimization in Telecommunication Networks,” by inventors Biswanath Mukherjee and Pulak Chowdhury, filed 30 Apr. 2010, the contents of which are herein incorporated by reference.

### BACKGROUND

1. Technical Field

This disclosure generally relates to telecommunication networks. More specifically, this disclosure relates to virtual topology adaptation for resource optimization in telecommunication networks.

2. Related Art

Resource management in telecommunication networks is becoming more complex as networks are growing larger in size. It is generally desirable to reduce the amount of resources (e.g., bandwidth, energy, etc.) required to satisfy a given traffic demand in a network.

### SUMMARY

Some embodiments described in this disclosure provide methods and apparatuses for managing a network, e.g., by performing virtual topology adaptation for resource optimization.

In some embodiments, a system can monitor traffic on the network to identify lightly loaded and/or heavily loaded links in the network. In response to identifying a lightly loaded link, the system can shift traffic from the lightly loaded link to one or more other links in the network. After the traffic has been shifted, the system can move circuitry associated with the lightly loaded link into a low-power state. In response to identifying a heavily loaded link, the system can activate a new link in the network by moving circuitry associated with the new link from a low-power state into a high-power state. After the new link has been activated, the system can shift traffic from the heavily loaded link to the new link.

In some embodiments, the system can identify a link as being lightly loaded if the traffic on the link is less than a low watermark. In some embodiments, the system can identify a link as being heavily loaded if the traffic on the link is greater than a high watermark.

In some embodiments, the system can shift traffic from a lightly loaded link to another link such that, after the traffic is shifted to the other link, the traffic on the other link is less than a high watermark.

In some embodiments, the circuitry associated with the identified link comprises a port in a line card in a router and/or a switch. In some embodiments, the circuitry associated with the identified link comprises a line card in a router and/or switch.

### BRIEF DESCRIPTION OF THE FIGURES

FIG. 1 illustrates a layered architecture of a telecommunication network in accordance with some embodiments described in this disclosure.

FIG. 2 presents a schematic of a modular architecture of a router and/or switch in accordance with some embodiments described in this disclosure.

FIG. 3 illustrates a time series of traffic load measurements in accordance with some embodiments described in this disclosure.

FIG. 4 presents a flowchart that illustrates a process for managing a network in accordance with some embodiments described in this disclosure.

FIGS. 5A and 5B illustrate an example of virtual topology adaptation in accordance with some embodiments described in this disclosure.

FIG. 6 illustrates a computer system in accordance with some embodiments described in this disclosure.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field programmable gate arrays (FPGAs), and other programmable-logic devices now known or later developed. When the hardware modules are activated, the hardware modules perform the methods and processes included within the hardware modules.

### Telecommunication Networks

A telecommunication network is often built using a layered architecture. Each layer is usually associated with a set of protocols which define the rules and conventions for processing packets or frames in that layer. Each lower layer performs a service for the layer immediately above it to help with processing packets. The Open Systems Interconnection (OSI) model defines a seven layered network architecture.

At a source node, each layer typically adds a header as the payload moves from higher layers to lower layers. A destination node typically performs the reverse process by processing and removing headers as the payload moves from lower layers to higher layers.

The physical layer may include physical transmission media (e.g., optical fibers) and physical layer switches (e.g., optical switches or nodes) which can be used by upper layers to communicate data. For example, data link layer frames (e.g., Ethernet frames) or networking layer packets (e.g., Internet Protocol (IP) packets) can be communicated over the physical layer through one or more optical fibers and/or switches.

The virtual topology of a networking layer refers to the connectivity between devices (e.g., switches and/or routers) that send, receive, and/or process data at that layer. Some embodiments described in this disclosure optimize resources by adapting the virtual topology of a networking layer.

The terms “switch” and “router” are used in this disclosure interchangeably to refer to a device that is capable of moving data from one port to another port. In the context of layer 1 (e.g., the optical layer), the term “switch” can refer to a device having multiple input and output ports that is capable of receiving data on an input port and sending the data on an output port. In the context of layers 2 and/or 3, the terms “switch” and “router” can refer to a device that is capable of forwarding packets based on information associated with the link layer and/or the network layer.

In this disclosure, the terms “frame,” “packet,” and “cell” generally refer to a group of bits. Specifically, the term “frame” does not necessarily refer to a layer 2 protocol data unit, and the term “packet” does not necessarily refer to a layer 3 protocol data unit. Further, unless otherwise stated, the term “IP” refers to both “IPv4” and “IPv6” in this disclosure.

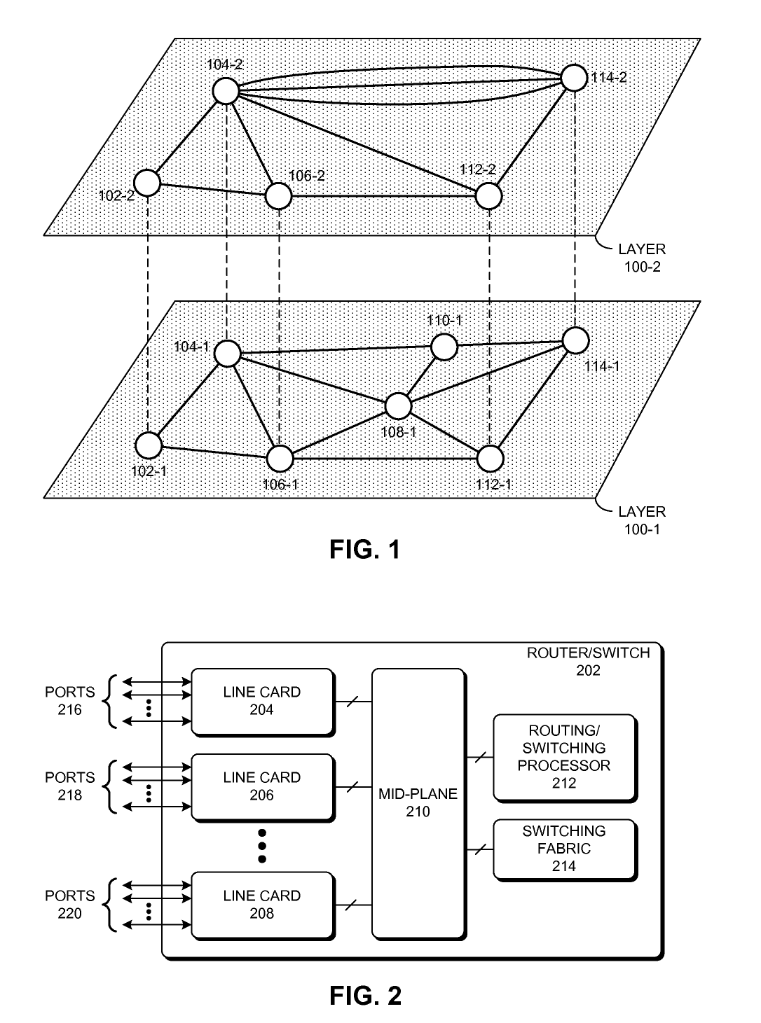

FIG. 1 illustrates a layered architecture of a telecommunication network in accordance with some embodiments described in this disclosure.

The telecommunication network shown in FIG. 1 illustrates networking layers 100-1 and 100-2. Layer 100-1 can include nodes 102-1, 104-1, 106-1, 108-1, 110-1, 112-1, and 114-1. A node can generally refer to a mechanism that can switch or route traffic between multiple links for one or more networking layers. Specifically, a node can be a switch and/or a router or a part (e.g., a line card) of a switch and/or router. Layer 100-2 can include nodes 102-2, 104-2, 106-2, 112-2, and 114-2. Note that nodes 108-1 and 110-1 in layer 100-1 do not have corresponding nodes in layer 100-2. Further, certain links in layer 100-1, such as the link between nodes 106-1 and 108-1, also do not have corresponding links in layer 100-2.

In some embodiments, layer 100-1 can correspond to a physical layer which may include a fiber plant and one or more optical switches. Specifically, each link shown in layer 100-1 can correspond to a wavelength in a wavelength division multiplexing system, an optical fiber, a fiber bundle, and/or a conduit through which one or more fiber bundles can be laid. Each node can correspond to a junction point or an optical switch where traffic can be switched between different links.

In some embodiments, layer 100-2 can correspond to an Ethernet or IP layer. Specifically, each link in layer 100-2 can correspond to an Ethernet link, and each node can correspond to a switch or a router. The topology (i.e., the connectivity between the nodes) of layer 100-2 can be referred to as the virtual topology of layer 100-2. The virtual topology can include multiple links between two nodes. For example, as shown in FIG. 1, the virtual topology of layer 100-2 includes three links between nodes 104-2 and 114-2. This may indicate that three ports in node 104-2 are coupled with three ports in node 114-2 via multiple fibers or via a single fiber by using wavelength division multiplexing.

In some embodiments, virtual topology adaptation can refer to a process for modifying the virtual topology of a network layer by increasing or decreasing the number of links between one or more pairs of nodes. For example, the virtual topology of layer 100-2 can be adapted (i.e., modified) by removing one of the three links between nodes 104-2 and 114-2, or by adding a fourth link between nodes 104-2 and 114-2.

In a virtual topology that corresponds to an OSI layer 2 (e.g., Ethernet) or OSI layer 3 (e.g., IP) network, a link between two nodes can be removed by deactivating the associated communication circuitry (e.g., ports and/or line cards) on the two nodes. Conversely, a link can be added between two nodes by activating the associated communication circuitry on the two nodes.

A telecommunication network, e.g., the Internet, can include multiple subnetworks or subnets. Routers and/or switches can forward data packets between the subnets. A router or switch can be viewed as performing control plane functions and data plane functions. The control plane functions can include maintaining and manipulating routing information, listening for updates from neighboring routers/switches, sending updates to neighboring routers/switches, maintaining packet classification information, classifying packets, processing or queuing packets based on their classification, performing access control, maintaining accounting and management statistics, etc. The data plane functions can include layer 2 (e.g., Ethernet) or layer 3 (e.g., IP) switching, and performing tasks related to switching such as encapsulation, checksum computation, updating TTL (time to live) or hop count, etc.

Routers and/or switches may connect autonomous systems (such as enterprises) or may be used inside the network of autonomous systems. Internet Service Providers (ISP) can connect several autonomous systems using high bandwidth Internet-scale routers/switches. Routers and/or switches with smaller bandwidths may be used to provide Small Office Home Office (SOHO) connectivity. Routers and/or switches can reside at the edge of the network (known as edge router/switch) or at the core of the network (known as core router/switch).

Some embodiments described in this disclosure perform virtual topology adaptation for resource optimization in a network that comprises routers and/or switches interconnected via links. The routers/switches may be used for interconnecting ISPs, for routing/switching traffic within ISPs, and/or for routing/switching traffic within small or large enterprise networks.

Smaller routers/switches (e.g., those that are used in a SOHO environment) typically use either a shared-memory or shared-bus architecture for packet switching. Unlike smaller routers/switches, larger routers/switches often have a modular hardware architecture. In some embodiments, a router/switch can include the following components: (a) one or more line cards, each with one or more ports, (b) one or more control cards which may include a routing/switching processor and memory, and (c) one or more multi-stage switching fabrics. These components can communicate with one another through a midplane. A midplane-based design may be preferred when the architecture is based on a common processor design with a wide variety of line cards. Specifically, a midplane-based architecture can enable the routing/switching processor card to manipulate and process packets of different formats from different line cards.

FIG. 2 presents a schematic of a modular architecture of a router and/or switch in accordance with some embodiments described in this disclosure.

Router/switch 202 can include lines cards 204, 206, and 208, mid-plane 210, route processor 212, and switching fabric 214. Routing/switching processor 212 and switching fabric 214 may be disposed on a single removable card (e.g., a controller card) or they may be disposed on different removable cards. Each line card can include one or more ports capable of sending and receiving data from another device, e.g., a neighboring router/switch. For example, line cards 204, 206, and 208 can include ports 216, 218, and 220, respectively.

Line cards 204, 206, and 208, routing/switching processor 212, and switching fabric 214 can communicate with one another through mid-plane 210. Specifically, line cards 204, 206, and 208, routing/switching processor 212, and switching fabric 214 can be coupled with mid-plane 210 using one or more signal lines which may carry control, data, and/or clock information.

In some architectures, when a packet arrives at an interface (e.g., a port on a line card), the line card can perform at least some of the processing, such as the processing related to quality of service (QoS), classification, policing, and shaping. Next, the packet can be queued on the line card until a forwarding decision has been made. While the packet is being processed on the line card, the header information of the packet can be sent to the routing/switching processor (e.g., routing/switching processor 212) for making a forwarding decision. The routing/switching processor can then send instructions and/or control signals (e.g., through mid-plane 210) to the line card and/or the switching fabric so that the packet is sent through the appropriate outgoing port on the appropriate line card.

Specifically, if the packet is to be sent through a port in the same line card, the packet can be placed in the transmit queue of the appropriate port. On the other hand, if the packet is to be forwarded through a port on another line card, the packet may be divided into smaller cells, which can then be sent through a single- or multi-stage switching fabric to the destination line card. The cells can then be reassembled in the destination line card to obtain the packet, and the packet can then be sent through the appropriate port on the destination line card.

For example, a packet can be received on one of the ports 216. Next, at least some processing can be performed on line card 204. The header information of the packet, meanwhile, can be sent to routing/switching processor 212 via mid-plane 210. routing/switching processor 212 may determine that the packet is to be forwarded through one of the ports on line card 206. Accordingly, line card 204 can divide the packet into smaller cells, and send them to switching fabric 214 through mid-plane 210. Switching fabric 214 can then provide the cells to line card 206 through mid-plane 210. Line card 206 can reassemble the cells to form the packet and place the packet in the transmission queue of the appropriate port on line card 206.

The traffic on a link in the network typically varies over time. The traffic on a link can be measured at regular intervals to create a time series of traffic load measurements. The time interval over which traffic load is measured can be of equal lengths or of different lengths. Further, these intervals can be overlapping or non-overlapping. The traffic load measurement can be for a unidirectional link, or a bidirectional link.

For example, if traffic load measurements are to be determined for each unidirectional link, the router/switch can determine the number of bytes that were sent over a unidirectional link from a first node to a second node during a given time interval. Next, the router/switch can store this number (with or without scaling and/or normalization) as the traffic load measurement associated with the unidirectional link for the given time interval.

On the other hand, if traffic load measurements are to be determined for each bidirectional link, the router/switch can determine the number of bytes that were sent or received over a bidirectional link between a first node and a second node during a given time interval. Next, the router/switch can store this number (with or without scaling and/or normalization) as the traffic load measurement associated with the bidirectional link for the given time interval.

Once a time series of traffic load measurements is obtained for a unidirectional or bidirectional link, a traffic load can be computed. In some embodiments, the traffic load at time t can be a function of the values in the time series of traffic load measurements.

In some embodiments, the traffic load at time t can be a weighted sum of at least some of the values in the time series of traffic load measurements. The coefficients used for determining the weighted sum can be a function of time. For example, in some embodiments, the traffic load L(t) at time t can be expressed as:

$$L ( t ) = {\sum }_{i = - N}^{M} f ( i ) \cdot m ( i ) , \qquad ( 1 )$$

where ƒ is the weighting function, m is a value in the time series of traffic load measurements, and i is an index used for identifying a particular value in the time series of traffic load measurements. Specifically, i=0 can correspond to the latest value in the time series before time t, i=−1, −2, −3, etc. can correspond to progressively earlier values in the time series, and i=1, 2, 3, etc. can correspond to progressively later values in the time series.

In some embodiments, M=0, ƒ can be an exponential function, e.g., ƒ(i)=aⁱ, where a>1 is a constant, and the computed traffic load value L(t) can be a exponentially weighted moving average. Specifically, in these embodiments, the traffic load L(t) at time t can be expressed as:

$$L ( t ) = {\sum }_{i = 0}^{N} {a}^{- i} \cdot m ( - i ) . \qquad ( 2 )$$

In some embodiments, ƒ can be a constant function, e.g., ƒ(i)=1/(M+N+1), and the computed traffic load value L(t) can be an average traffic load. These traffic load expressions have been presented only for purposes of illustration and description. They are not intended to be exhaustive or to limit the embodiments to the forms disclosed. Accordingly, many modifications and variations will be apparent to practitioners having ordinary skill in the art.

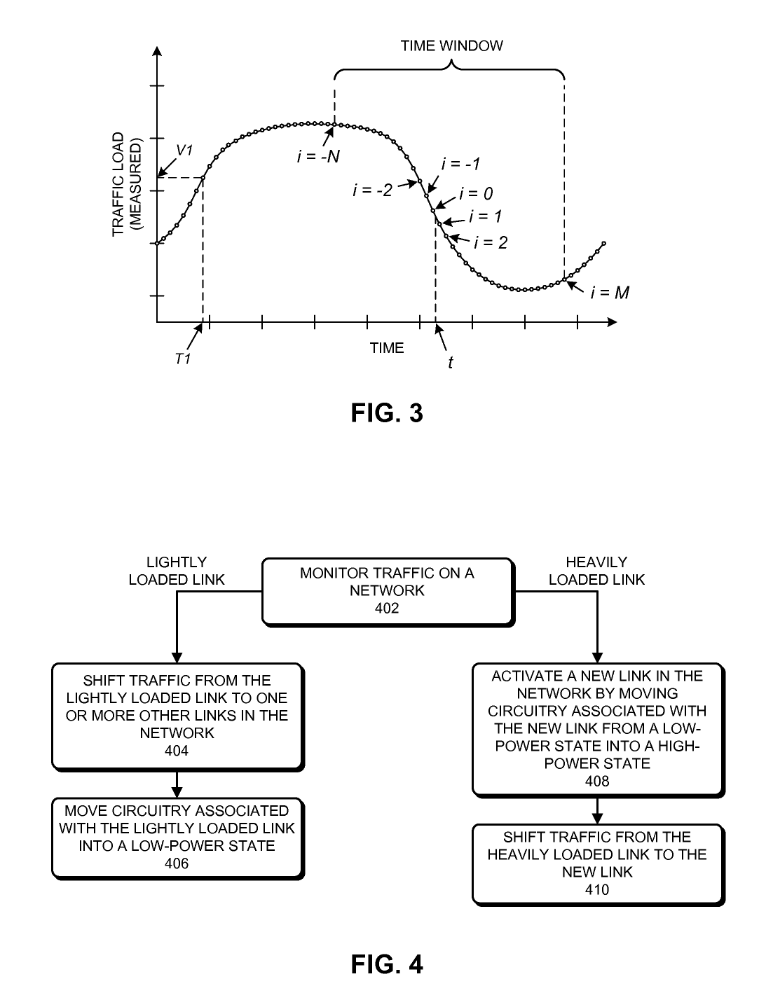

FIG. 3 illustrates a time series of traffic load measurements in accordance with some embodiments described in this disclosure.

The X-axis corresponds to time and the Y-axis corresponds to traffic load measurement values. Each circle in the plot represents a traffic load measurement value. For example, at time T1 the measured traffic load was equal to V1. As mentioned above, in some embodiments, the traffic load at time t can be equal to a weighted sum of at least some values in the time series of traffic load measurements.

For example, consider the traffic load expression shown in Equation (1). As shown in FIG. 3, time t occurs between the time instances associated with two measurement values in the time series. The earlier of these two measurements can be associated with the index value i=0. Progressively earlier values can be associated with index values −1, −2, −3, etc. as shown in FIG. 3. Progressively later values can be associated with index values 1, 2, 3, etc. as shown in FIG. 3. The range of index values that are used for computing the traffic, i.e., values from i=−N to i=M, defines the time window that is used for computing the traffic load.

Some embodiments include a centralized and/or distributed network resource manager which optimizes resource (e.g., energy) consumption of routers/switches. In some embodiments, a resource manager can be installed on each router/switch that is being managed. The resource managers can then cooperate to manage the network resources in a centralized and/or distributed fashion. For example, as traffic fluctuates over time, one or more resource managers can monitor traffic flow at each router/switch systematically, and the virtual topology can be adapted accordingly. In some embodiments, the resource managers do not make any assumptions on future traffic pattern. In some embodiments, the topology adaptation process can be hitless since the continuous measurement and reconfiguration system can make adjustments without hampering the system efficiency. In some embodiments, reconfiguration of the topology may occur only if there is an opportunity of resource savings without jeopardizing the network performance.

A resource manager or resource agent can generally refer to one or more mechanisms that are capable of, either individually or in concert, monitoring traffic on a network and adapting the virtual topology for resource optimization. The terms “resource manager” and “resource agent” are used interchangeably in this disclosure. A resource manager or resource agent can be implemented in software, hardware, or a combination of software and hardware. In some embodiments, a resource agent can monitor the traffic flow from all the routers/switches in the network periodically. The resource agent can then shift load from one line card to another to create opportunities for shutting down ports and/or line cards. Next, the resource agent can decide on what part of the router/switch can be shut down.

In some embodiments, resource agents at different routers/switches can collaborate through a centralized system and/or in a distributed manner to share network state and traffic information. In some embodiments, the resource agent can track the network state by collecting data of all traffic flows in a router/switch and simulating the current network state for making decisions. The resource agent can be a stand-alone module that can executed on top of any router/switch Operating System (OS).

In some embodiments, the resource agent can work in an automated mode and/or a suggestive mode. In the automated mode, the resource agent can automatically shut down or bring up router/switch elements to reduce resource usage (e.g., save energy). In the suggestive mode, the resource agent can provide suggestions to an operator as to how energy savings can be accomplished by turning off parts of one or more routers/switches. The operator can then decide whether or not to act on the suggestion, and the resource agent can process the operator's decision accordingly. In a combined mode, the resource agent can take certain actions automatically, and provide suggestions for other actions. For example, in some embodiments, the resource agent can automatically bring up a link (e.g., in response to detecting that the traffic load on one or more links is higher than desired), but it may suggest links that can be brought down to conserve resources.

In some embodiments, the resource agent may provide an expiry time with each suggestion, i.e., if the operator does not act on the suggestion before the expiry time, the suggestion is deleted. This can prevent the operator from performing an action that was based on an outdated network state. For example, suppose the resource agent suggests bringing down the link that currently has a very low traffic load. However, by the time the operator acts on the suggestion, the traffic on the link may have increased so that it is no longer advisable to bring down the link. An appropriately selected expiry time may prevent such situations.

In some embodiments, the resource agent may be able to explicitly cancel a previous suggestion. Note that automatically deleting a suggestion after a predetermined amount of time (i.e., the expiry time) has passed may delete suggestions that may still be valid. Therefore, in some embodiments, the system may keep a suggestion alive until an explicit delete request is received from the resource agent. For example, if the resource agent provides a suggestion to an operator to bring down a link, and subsequently the traffic on link increases so that the previous suggestion is no longer valid, the resource agent can send an explicit request to cancel or delete the previous suggestion.

In some embodiments, a resource agent can selectively move one or more parts (e.g., ports, line cards, etc.) of one or more routers/switches into a low-power state through intelligent load management. Specifically, before moving the one or more parts of a router/switch to a low-power state, the resource agent can rearrange traffic from lightly-loaded links to moderately-loaded links, and then the circuitry (e.g., ports and/or line cards) associated with the unused links can be moved into a low-power state.

In some embodiments, the decision of whether or not to move a particular part of a router/switch from one state to another can be based on one or more thresholds or watermarks. Specifically, in some embodiments, the system uses two watermarks: a high watermark and a low watermark. In some embodiments, the high and low watermarks can be values between 0 and 1. The watermarks can correspond to the utilization of a link, i.e., the ratio between a traffic load value and the link's capacity. As described above, the traffic load of a unidirectional or bidirectional link can generally be any arbitrary function of the time series of traffic load measurements for the link.

In some embodiments, if the traffic load on an active link crosses above the high watermark (say 0.8), the resource agent can signal an onset of an overload condition in the network. In response to this event, the resource agent can bring up a new link (e.g., a line card or a port on a line card) to carry the traffic load. On the other hand, if the traffic load on a link (e.g., a line card or a port) falls below a low watermark (say 0.2), the resource agent can attempt to shift the load to one or more target links that are currently operating under the high watermark. Specifically, if the traffic can be shifted to the one or more target links without causing the traffic load of the one or more target links to go over the high watermark, then the traffic can be shifted accordingly, and the link that was operating under the low watermark can be moved into a low-power state, thereby optimizing resource (energy) usage.

FIG. 4 presents a flowchart that illustrates a process for managing a network in accordance with some embodiments described in this disclosure.

The process can begin with a system (e.g., a network management system) monitoring traffic on a network (operation 402). Specifically, monitoring the traffic on the network can include identifying lightly and/or heavily loaded links in the network.

In response to identifying a lightly loaded link, the system can shift traffic from the lightly loaded link to one or more other links in the network (operation 404). After the traffic has been shifted, the system can move circuitry associated with the lightly loaded link into a low-power state (operation 406).

In response to identifying a heavily loaded link, the system can activate a new link in the network by moving circuitry associated with the new link from a low-power state into a high-power state (operation 408). After the new link has been activated, the system can shift traffic from the heavily loaded link to the new link (operation 410).

In some embodiments, the system can compute the traffic load on a link based on a time series of traffic load measurements. In some embodiments, the traffic load on a link can be a weighted average of the traffic load measurements (see e.g., Equation (1)). In some embodiments, the traffic load can be an exponentially weighted moving average (see e.g., Equation (2)).

The circuitry associated with the identified link can generally be any circuitry that is used for receiving, transmitting, and/or processing data associated with the identified link. Specifically, the circuitry associated with the identified link can include one or more ports and/or line cards. Circuitry associated with a link may support multiple power states, including a low-power state and a high-power state. The power consumption of the circuitry in the low-power state is less than the power consumption of the circuitry in the high-power state.

Activating a new link can include configuring the new link. For example, if the new link carries layer 3 traffic (e.g., IP traffic), then the new link may need to be configured with a layer 3 address (e.g., an IP address) before traffic can be shifted to the new link.

In some embodiments, the traffic at a switch or router/switch can be shifted from one link to another link by modifying a forwarding and/or routing table. For example, in FIG. 2, a resource agent on router/switch 202 can configure route processor 212 so that traffic that would have been sent over a lightly loaded link is now sent over other links. Similarly, once a new link has been activated, the resource agent on router/switch 202 can configure route processor 212 so that traffic that is currently being sent over a heavily loaded link is now sent over the new link.

In some embodiments, the resource agent can determine that a link is lightly loaded if the traffic load of the link is less than a low watermark. The resource agent can determine that the link is highly loaded if the traffic load on the link is greater than a high watermark.

In some embodiments, the resource agent can use a set of rules to determine whether or not to identify a link as a lightly and/or highly loaded link. For example, in some embodiments, the resource agent may determine that a link is lightly loaded if a given number of traffic load computations (e.g., the last five traffic load computations) were less than the low watermark. Similarly, the resource agent may determine that a link is heavily loaded if any one of a given number of traffic load computations (e.g., the last five traffic load computations) was greater than the high watermark. These examples of the rules and/or criteria for determining whether or not a link is lightly and/or heavily loaded have been presented only for purposes of illustration and description. They are not intended to be exhaustive or to limit the embodiments to the forms disclosed. Accordingly, many modifications and variations will be apparent to practitioners having ordinary skill in the art.

In some embodiments, once a lightly loaded link is identified, the resource agent can determine a set of target links to which the traffic on the lightly link can be shifted. Specifically, the resource agent can determine a set of target links such that, after the traffic on the lightly loaded link is shifted to the set of target links, the traffic load on the set of target links does not exceed a high watermark. Further, the resource agent can also determine whether or not the type of traffic that is currently being carried on the lightly loaded link can be carried on the target links. For example, if a candidate target link is only capable of carrying layer 2 traffic, and the traffic on the lightly loaded link is layer 3 traffic, then the resource agent may decide not to include this candidate target link in the set of target links. The type of traffic that is carried on a link can refer to the specific combinations of protocols that are configured on the link, e.g., IP-over-Gigabit Ethernet, IP-over-Frame Relay, etc. Once a suitable set of target links is determined, the resource agent can begin shifting the traffic. If the resource agent is unable to determine such a set of target links, then the resource agent may decide not to shift traffic from the lightly loaded link.

In some embodiments, the resource agent can first identify heavily loaded links, and activate new links as required. Once the traffic on the heavily loaded links has been shifted to the new links, the resource agent can then identify lightly loaded links, move traffic from the lightly loaded links to other links, and move circuitry associated with the lightly loaded links from a high-power state into a low-power state.

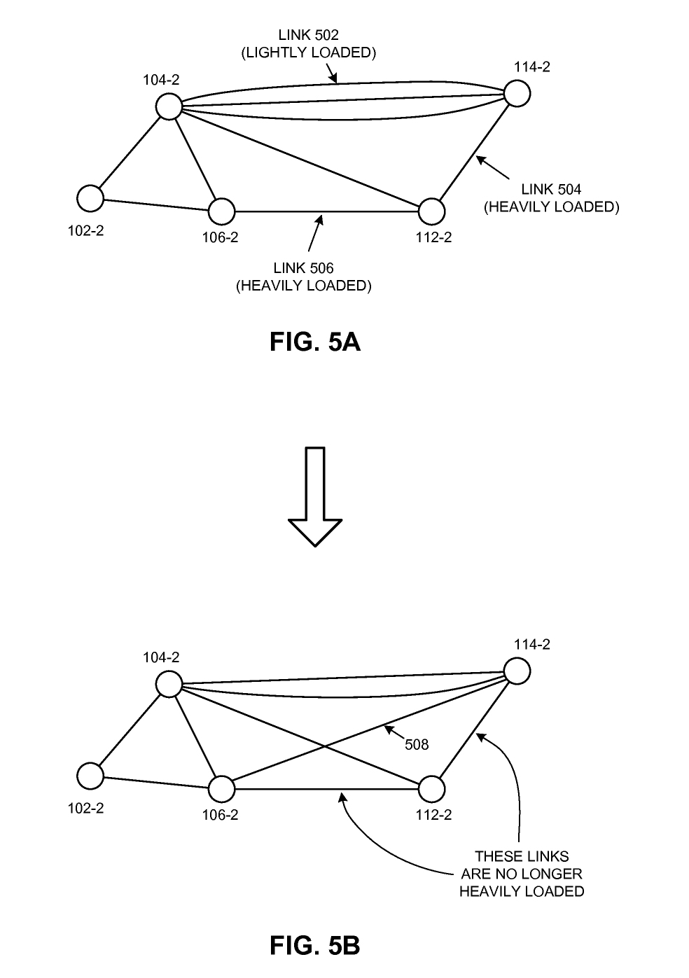

FIGS. 5A and 5B illustrate an example of virtual topology adaptation in accordance with some embodiments described in this disclosure. The virtual topology illustrated in FIG. 5A is the same as the virtual topology of layer 100-2 shown in FIG. 1.

The system (e.g., a network management system and/or a set of resource agents in the network) may monitor traffic and identify links 504 and 506 as heavily loaded links. Next, the system may analyze the traffic on heavily loaded links 504 and 506 and determine that a significant portion of the traffic on links 504 and 506 is between nodes 106-2 and 114-2, and that node 112-2 is merely acting as a transit node. Further, the system may determine that it is possible to set up a direct link between nodes 106-2 and 114-2. Accordingly, the system may decide to set up new link 508 (shown in FIG. 5B) between nodes 106-2 and 114-2 to offload traffic from heavily loaded links 504 and 506.

Next, the system may identify link 502 as a lightly loaded link. The system may decide to shift the traffic on link 502 to the two other links between nodes 104-2 and 114-2. Once the traffic on link 502 has been shifted, the system may bring down link 502 by moving circuitry associated with link 502 from a high-power state into a low-power state. FIG. 5B shows the result of activating new link 508 and bringing down lightly loaded link 502.

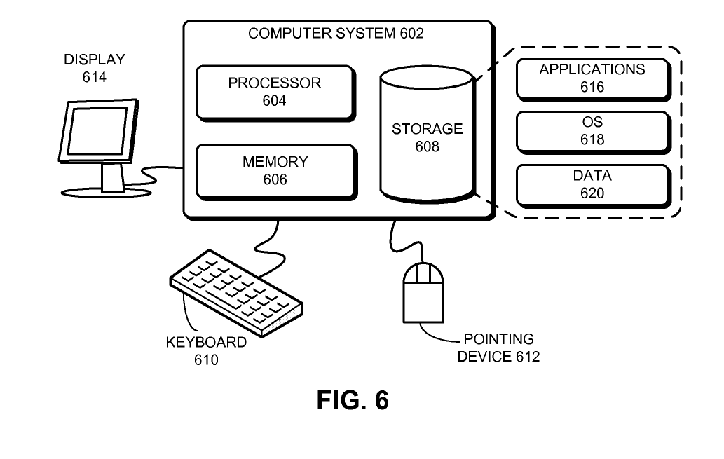

FIG. 6 illustrates a computer system in accordance with some embodiments described in this disclosure.

A computer system can generally include any device (e.g., a router/switch or a network management workstation) that is capable of performing computations. A computer system, such as computer system 602, can include processor 604, memory 606, and storage device 608. Storage device 608 can store operating system 616, application 618, and data 620. Data 620 can include a description of a network state, e.g., a description of the nodes, links, and the traffic loads on each of the links. Application 618 can include resource agent software and/or network management software.

Computer system 602 may automatically perform any method that is implicitly or explicitly described in this disclosure. Specifically, during operation, computer system 602 can load application 618 into memory 606. Application 618 can then perform virtual topology adaptation for resource optimization.

In some embodiments, computer system 602 can be coupled to display device 614, keyboard 610, and pointing device 612.

The foregoing descriptions of embodiments of the present invention have been presented only for purposes of illustration and description. They are not intended to be exhaustive or to limit the present invention to the forms disclosed. Accordingly, many modifications and variations will be apparent to practitioners having ordinary skill in the art. Additionally, the above disclosure is not intended to limit the present invention. The scope of the present invention is defined by the appended claims.

What is claimed is:

1. A method for managing a network, comprising:
monitoring traffic on the network, wherein said monitoring includes identifying lightly loaded links in the network;
in response to identifying a lightly loaded link, shifting traffic from the lightly loaded link to one or more other links in the network; and
after the traffic has been shifted, moving circuitry associated with the identified link into a low-power state.

2. The method of claim 1, wherein said identifying lightly loaded links includes identifying a link having traffic that is less than a low watermark.

3. The method of claim 1, wherein said shifting traffic from the lightly loaded link to one or more other links includes shifting the traffic to a link such that, after the traffic is shifted to the link, the link has traffic that is less than a high watermark.

4. The method of claim 1, wherein the circuitry associated with the lightly loaded link comprises a port in a line card in a router or a switch.

5. The method of claim 1, wherein the circuitry associated with the lightly loaded link comprises a line card in a router or a switch.

6. The method of claim 1, wherein said monitoring additionally includes identifying heavily loaded links in the network, and wherein the method further comprises:
in response to identifying a heavily loaded link, activating a new link in the network by moving circuitry associated with the new link from a low-power state into a high-power state; and
after the new link has been activated, shifting traffic from the heavily loaded link to the new link.

7. The method of claim 6, wherein said identifying heavily loaded links includes identifying a link having traffic that is greater than a high watermark.

8. A non-transitory computer-readable storage medium storing instructions that when executed by a computer cause the computer to perform a method for managing a network, comprising:
monitoring traffic on the network, wherein said monitoring includes identifying lightly loaded links in the network;
in response to identifying a lightly loaded link, shifting traffic from the lightly loaded link to one or more other links in the network; and
after the traffic has been shifted, moving circuitry associated with the identified link into a low-power state.

9. The computer-readable storage medium of claim 8, wherein said identifying lightly loaded links includes identifying a link having traffic that is less than a low watermark.

10. The computer-readable storage medium of claim 8, wherein said shifting traffic from the lightly loaded link to one or more other links includes shifting the traffic to a link such that, after the traffic is shifted to the link, the link has traffic that is less than a high watermark.

11. The computer-readable storage medium of claim 8, wherein the circuitry associated with the lightly loaded link comprises a port in a line card in a router or a switch.

12. The computer-readable storage medium of claim 8, wherein the circuitry associated with the lightly loaded link comprises a line card in a router or a switch.

13. The computer-readable storage medium of claim 8, wherein said monitoring additionally includes identifying heavily loaded links in the network, and wherein the method further comprises:
in response to identifying a heavily loaded link, activating a new link in the network by moving circuitry associated with the new link from a low-power state into a high-power state; and
after the new link has been activated, shifting traffic from the heavily loaded link to the new link.

14. The computer-readable storage medium of claim 13, wherein said identifying heavily loaded links includes identifying a link having traffic that is greater than a high watermark.

15. A system, comprising:
a processor; and
a storage medium storing instructions that are capable of being executed by the processor, the instructions comprising:
instructions for monitoring traffic on the network, wherein said monitoring includes identifying lightly loaded links in the network;
instructions for, in response to identifying a lightly loaded link, shifting traffic from the lightly loaded link to one or more other links in the network; and
instructions for, after the traffic has been shifted, moving circuitry associated with the identified link into a low-power state.

16. The system of claim 15, wherein said identifying the lightly loaded links includes identifying a link having traffic that is less than a low watermark.

17. The system of claim 15, wherein said shifting the traffic from the lightly loaded link to the one or more other links includes shifting the traffic to a link such that, after the traffic is shifted to the link, the link has traffic that is less than a high watermark.

18. The system of claim 15, wherein the circuitry associated with the lightly loaded link comprises a port in a line card in a router or a switch.

19. The system of claim 15, wherein the circuitry associated with the lightly loaded link comprises a line card in a router or a switch.

20. The system of claim 15, wherein said monitoring additionally includes identifying heavily loaded links in the network, and wherein the instructions further comprise:
instructions for, in response to identifying a heavily loaded link, activating a new link in the network by moving circuitry associated with the new link from a low-power state into a high-power state; and
instructions for, after the new link has been activated, shifting traffic from the heavily loaded link to the new link.

21. The system of claim 20, wherein said identifying the heavily loaded links includes identifying a link having traffic that is greater than a high watermark.
